(19) United States
(12) Patent Application Publication
(10) Pub. No.: US 2003/0101139 A1
(43) Pub. Date: May 29, 2003

(54) Method of and system for storing a data item

(76) Inventor: Bjoern Christiaan Wouter Kaag, Eindhoven (NL)

Correspondence Address: Philips Electronics North America Corporation, Corporate Patent Counsel, 580 White Plains Road, Tarrytown, NY, 10591, US

(21) Appl. No.: 10/130,041

(22) PCT Filed: Sep. 12, 2001
(86) PCT No.: PCT/EP01/10582

(51) Int. Cl. G06F 17/60

(52) U.S. Cl. 705/50

(57) ABSTRACT

A data item is identified by a code word that is build up from a sequence of code word components. This data item and code word is stored in a number of entries in a table (102), whereby each code word component is stored in a separate entry. The table 102 has a column 104 for storing the values of the code word components, a column 106 for storing the reference to a previously stored code word component, if present, and a column 108 for storing the data item.

The invention relates to a method of storing a data item identified by a code word containing a sequence of code word components.

The invention further relates to a method of retrieving a data item identified by a code word containing a sequence of code word components.

The invention further relates to a system for storing a data item identified by a code word containing a sequence of code word components.

It is well known to identify a data item by means of a code word and to use the code word to store and later retrieve the data item from a storage space. The code word is then typically used to identify in the storage space a particular location, in which the data item is stored. Examples are a salary number in a personnel registration system and a product number in a stock management system. The salary number is used to locate the record or records of the corresponding person and the product number is used to locate the information of the particular product.

A further example of the use of such a code word is in a system implementing the so-called Simple Network Management Protocol (SNMP) as described in the document ‘An Introductory Overview of SNMP’, DDRI, Diversified Data Resources, Inc, 1999, Novato, Calif. 94947, USA. In this protocol, a number of objects have been defined that carry certain information relating to the network. Such an object is identified by a so-called Object Identifier (OID) which is a compound code word. The OID consists of a sequence of components. Each of the components relate to a certain hierarchy level defining a certain aspect of the object and the total sequence uniquely identifies the object at hand. The OID ‘1.3.6.1.2.1.1.3.0’ for example identifies the object ‘sysUpTime, which is the elapsed time since the managed device was booted. Another example is the OID ‘1.3.6.1.3.4’ which is the name of the managed device. A managed device has respective software function to supply the current value of relevant objects when requested. To this end, the device maintains a database of associations between an OID of an object and the software function that provides the value for that object.

It is an object of the invention to provide a method of storing a data item as described in the preamble which is more efficient than the known method. This object is achieved according to the invention in a method of storing a data item identified by a code word, the code word containing a sequence of code word components, wherein the code word is stored in a group of entries in a storage space in the following steps:

1) in each entry of the group storing a particular one of the code word components,

2) in each entry of the group storing a reference to an entry containing the code word component of a neighboring code word component, if present, to allow reconstruction of the code word from the entries in the group,

3) in at least one entry of the group storing a reference to the data item.

By storing a single code word component per entry, rather than in one entry all code word components making up the complete code word, an entry may be used by different code words. If two code words have one or more code word components in common, these common code words need only be stored once. Storing the code word components according to the invention saves storage space when a number of code words have sufficient code word components in common. In the example of SNMP above, where the code word is an OID defined according to the standard, many different code words have a significant number of code words components in common, thus saving storage space. Furthermore, if contrary to the invention, an entry were designed to be able to store the complete code word, the entry would need to be as large as the longest sequence of code word components that is used. This would result in a waste of storage space for the code words containing less code word components.

An embodiment of the method of storing a data item according to the invention is described in claim 2. Applying a hash function to the code word component is a simple way to determine an entry in the storage space for storing the code word component. The hash function maps the range of values of the code word component onto the range of available entries in an easy way.

An embodiment of the method of storing a data according to the invention is described in claim 3. Storing in an entry containing a particular code word component the reference to the entry containing the previous code word component, provides an easy mechanism to reconstruct the complete code word from the stored entries.

It is a further object of the invention to provide a method of retrieving a data item as described in the preamble which is more efficient than the known method. This object is achieved according to the invention in a method of retrieving a data item identified by a code word, the code word containing a sequence of code word components, wherein the data item and the code word are stored in a group of entries in a storage space, the method comprising the following steps:

1) determining the location of a potential entry in the storage space on the basis of the first code word component in the sequence and accessing this potential to verify whether it relates to such a first code word,

2) repeatedly determining a potential entry in the storage space on the basis of the subsequent code word components in the sequence and accessing this potential entry to verify whether it relates to the current code word, and

3) retrieving from the last accessed entry a reference to the data item.

Retrieving one code word component per entry, rather than all code word components making up the complete code word from one entry, allows a more efficient storing of the code word. By storing a single code word component per entry, rather than in one entry all code word components making up the complete code word, an entry may be used by different code words. If two code words have one or more code word components in common, these common code words need only be stored once. Storing the code word components according to the invention saves storage space when a number of code words have sufficient code word components in common. Furthermore, the fact that fewer separate components are stored in the storage space allows for a faster search to and retrieval of a data item on the basis of a given code word.

It is a further object of the invention to provide a system for storing a data item as described in the preamble which is more efficient than the known system. This object is achieved according to the invention in a system for storing a data item identified by a code word, the code word containing a sequence of code word components, the system comprising a storage space containing a group of entries and a storing unit arranged to:

1) store in each entry of the group a particular one of the code word components,

2) store in each entry of the group a reference to an entry containing the code word component of a neighboring code word component, if present, to allow reconstruction of the code word from the entries in the group,

3) store in at least one entry of the group a reference to the data item.

The invention and its attendant advantages will be further elucidated with the aid of exemplary embodiments and the accompanying schematic drawings, wherein:

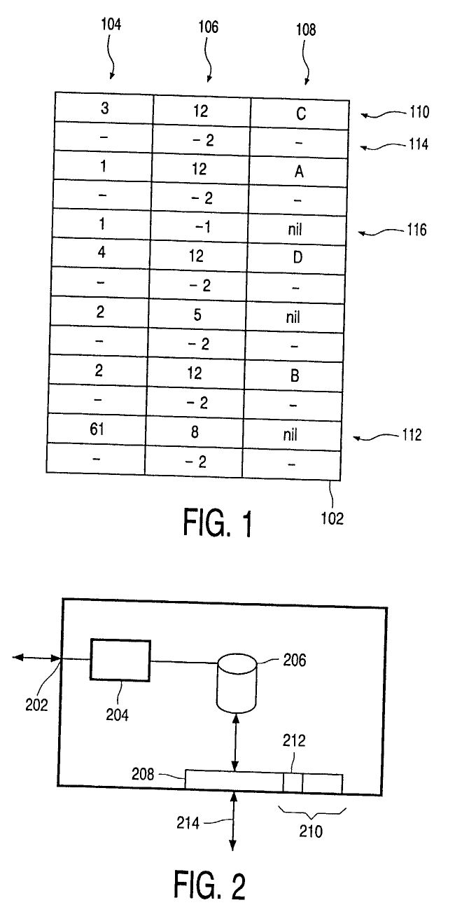

FIG. 1 shows a storage space with data items and code words stored according to the invention, and

FIG. 2 schematically shows a system for storing a data item identified by a code word according to the invention.

Corresponding features in the various Figures are denoted by the same reference symbols.

FIG. 1 shows a storage space with data items and code words stored according to the invention. In this embodiment, the storage space is used to store associations between an Object Identifier (OID) of an object defined in the Simple Network Management Protocol (SNMP) and the software function implementing the functionality for that object, i.e. the function for accessing the value of the object. SNMP and the objects used therein, are described in the document ‘An Introductory Overview of SNMP’, DDRI, Diversified Data Resources, Inc, 1999, Novato, Calif. 94947, USA. An OID is composed of OID components. An OID may contain up to a maximum of 128 OID component and an OID component may have a maximum value of (2ˆ 32)−1. The storage space in this embodiment is implemented as a table 102. The association between an OID and its implementing function is stored by storing the address of the software function in the table. In the example shown in FIG. 1, the following OIDs are stored:

| | |
|---|---|
| OID 1.2.61.1 | function A |
| OID 1.2.61.2 | function B |
| OID 1.2.61.3 | function C |
| OID 1.2.61.4 | function D |

The size of the table and the numbers used are to illustrate the operation of the invention.

The table 102 has 3 columns: a column 104 for storing OID components, a column 106 for storing entries that contain the previous OID component of a given OID and a column 108 for storing the address to the function of an OID. The rows of the table 102 form the respective entries. Thus an entry has 3 fields and stores an OID component in the following way: the first field contains an OID component of a particular OID, the second field contains a reference to the entry containing the previous OID component of that OID and the third field contains the address of the function of that OID. In this implementation, the size of the first field is 32 bits, the size of the second field is 32 bits and the size of the third field 16 bits. This means that the total size of an entry 80 bits or in different terms: 10 bytes of 8 bits. For example, entry 110 contains the fourth OID component of the OID ‘1.2.61.3’:

the first field contains the value ‘3’ of the OID component,

the second field contains the reference to the 12^{th} entry of the table (indicated with reference numeral 112) containing the third OID component of the OID, and

the third field contains the address to function C.

Depending on the situation at hand, the fields may contain specific values to indicate a special condition as described below.

The table 102 has a number of entries, 13 in the example but in practice much more, and these are initially all empty. An empty entry contains a signal indicating that it is empty and that an OID component may be stored in it. In this embodiment, an empty entry is identified as such by storing the value ‘−2’ in the second field of that entry. Entry 114 is an example of an empty entry. If the first OID component of an OID is stored, there is no previous OID component and therefore, the second field cannot be filled with the reference to such previous OID component. Therefore, the second field of an entry containing the first OID component of an OID contains the value ‘−1’. For example entry 116. When the last OID component of an OID is stored, processing the OID is finished and the OID is fully qualified in the table. Therefore, the address to the function implementing the OID is only stored in the entry containing the last OID component. Thus entry 110, containing the last OID component of OID ‘1.2.61.3’, has the address of function C in its third field while entry 112, containing the third OID component of OID ‘1.2.61.3’, has the value ‘nil’ in its third field.

Storing the OID ‘1.2.61.1’ and its associated function is done as follows. An entry is determined for the first OID component ‘1’. This is done by applying a hash function to this OID component, which function returns according to the example the value 5. This means that the OID component ‘1’ is stored in the 5^{th} entry of the table, which is indicated with reference numeral 116. The first field of this entry is filled with the value ‘1’, the second field with the value ‘−1’ since there is no previous OID component, and the third field is filled with the value ‘nil’ since the OID component is not the last one of the OID. Subsequently, the second OID component ‘2’ is processed. Applying the exemplary hash function returns the value 8, which means that the second OID component is stored in the 8^{th} entry of the table. The first fields contains the value ‘2’. The second field contains the value ‘5’, indicating that the previous OID component of this OID has been stored in the 5^{th} entry. The third field contains the value ‘nil’ since it is not the last OID component of the OID. Then the third OID component is processed. This OID component ‘61’ is stored in the 12^{th} entry with the fields ‘61’, ‘8’ and ‘nil’ respectively. Finally, the last OID component ‘1’ is stored. This OID component is stored in the first field of the 3^{rd} entry and now the address of function A is entered in the third field of that entry.

When the second OID ‘1.2.61.1’ has been stored as described above, storing the second OID 1.2.61.2’ is as follows. When processing the first OID component, it appears that this must be stored in the 5^{th} entry. This entry is not empty, however it is determined that the information in that entry is the same as what need to be stored for this first OID component. Therefore, instead of finding a next, empty entry in the table the 5^{th} entry is regarded as the entry of the first OID component of the second OID as well. Thus, the 5^{th} entry is shared by the first and the second OID. Exactly the same happens for the second and the third component of the second OID. The last OID component of the second OID, is stored in the 10^{th} entry which was empty until then. This last OID component effectively finishes processing the second OID and completely qualifies the second OID. Therefore, the function B associated with the second OID is stored in this 10^{th} entry.

Storing the OIDs ‘1.2.61.3’ and ‘1.2.61.4’ results to the same conditions as storing OID ‘1.2.61.2’, namely that they are only different with respect to their fourth OID component. This means that the 5^{th}, the 8^{th} and the 12^{th} entry are shared by all 4 OIDs and this results to an efficient storage in the table. OIDs are defined in a standardized hierarchy where the sequence of the OID components from left to right reflects the level in the hierarchy from top to bottom. OIDs typically share a substantial number of OID components from left to right because the top levels are the same for many OIDs.

As described above, the entry in which a particular code word component is to be stored is determined by using a hash function. This function translates the value of a code word component into an entry number that exists in the table. If it is found out that a calculated entry is already occupied by a different code word component, this is called a collision, a new entry number is determined by applying an offset to the previous entry number. In this embodiment, a hash value is calculated by using the formula:

hash=old_hash*19+component_value+7

wherein:

old_hash is the hash value calculated for the previous OID component,

component_value is the value of the present OID component.

This hash value is mapped onto the available range of entries in the table. If the number of used entries in the table increases, the chance of a collision increases and the efficiency of the process of determining an entry in the table decreases. Therefore, the filling degree of the table is observed and when it has reached a certain threshold, the table is expanded.

Table 102 is filled as described above with the associations between OIDs and the respective software functions for these OIDs. This information is then available for the program running on the device containing the table. If a request is received regarding a particular OID, the table 102 is used to find the address of the software function that needs to be called to service the request. Such request may be the request for the value of the object defined by the particular OID and upon being called, the software function retrieves this value from the appropriate place and returns it. The process of finding the address of a function on the basis of a particular OID is similar to the process of storing as described above. An entry for the first OID component is determined by using the hash function and it is checked whether the entry indeed stored this OID component, i.e. that no collision occurs. If a collision occurs, a next entry is calculated using the same offset as for storing OID component. If no collision occurs, the entry for second OID component is determined and its fields are retrieved. It is checked whether this entry relates to an OID component that is part of the currently processed OID by verifying whether the second field refers back to the entry containing the just processed first OID component. The processing continues for all OID components in the sequence until the last OID component of the OID has been processed. Then the address to the desired software function is retrieved from the third field of this last entry and made available for calling this function.

FIG. 2 schematically shows a system for storing a data item identified by a code word according to the invention. This system may be part of a device in a network in which the device is managed according SNMP. Such a device may be a set-top box that receives video information and processes this to be presented on a display device, like a television receiver. The system has a connection 202 through which, amongst others, a request related to a particular object is received. This request contains the OID of the particular object. This request is processed by a so-called SNMP agent 204 that accesses the Management Information Base (MIB) 206 to determine which function must be called for this particular object. The MIB implements logical grouping of management information and read-write access to the managed objects. The storing could be requested by modules in the instrumentation base that want to offer management information to the system by virtue of their instrumentation functions. The MIB contains the associations between the OIDs and the respective software functions and is based on a table as shown in FIG. 1. Furthermore, the system has a layer 208 for accessing the software functions. This layer de-couples the dependencies between the MIB and the software functions. This layer 208 has a storing function 210 for storing the OID and the function address as described above. To this end, the storing unit may contain a hash function 212 to determine the entries in the table. When the address for the software function corresponding with the received request has been determined, a call to that function is dispatched via an interface 214. If the requests concerned the retrieval of the value of an object, this value is returned via the interface 214 by the SNMP agent 204 to the connection 202.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A method of storing a data item identified by a code word, the code word containing a sequence of code word components, wherein the code word is stored in a group of entries in a storage space in the following steps:
1) in each entry of the group storing a particular one of the code word components,
2) in each entry of the group storing a reference to an entry containing the code word component of a neighboring code word component, if present, to allow reconstruction of the code word from the entries in the group,
3) in at least one entry of the group storing a reference to the data item.

2. A method of storing a data item as claimed in claim 1, wherein the entry for a given code word component is determined by applying a hash function to the given code word component.

3. A method of storing a data item as claimed in claim 1, wherein the entries of the group are accessed in the order of the sequence of the code word components constituting the code word and wherein step 2) is realized by storing a reference to the entry containing the code word component of the previously stored code word component in the sequence, if present.

4. A method of retrieving a data item identified by a code word, the code word containing a sequence of code word components, wherein the code word is stored in a group of entries in a storage space, the method comprising the following steps:
1) determining the location of a potential entry in the storage space on the basis of the first code word component in the sequence and accessing this potential to verify whether it relates to such a first code word,
2) repeatedly determining a potential entry in the storage space on the basis of the subsequent code word components in the sequence and accessing this potential entry to verify whether it relates to the current code word, and
3) retrieving from the last accessed entry a reference to the data item.

5. A method of retrieving a data item according to claim 4, whereby the location of the entry for a given code word component is determined by applying a hash function to the given code word component.

6. A system for storing a data item identified by a code word, the code word containing a sequence of code word components, the system comprising a storage space containing a group of entries and a storing unit arranged to:
1) store in each entry of the group a particular one of the code word components,
2) store in each entry of the group a reference to an entry containing the code word component of a neighboring code word component, if present, to allow reconstruction of the code word from the entries in the group,
3) store in at least one entry of the group a reference to the data item.

7. A system as claimed in claim 6, wherein the storing unit comprises a hashing function to determine the entry in which a particular code word component is stored.

8. A system as claimed in claim 6, wherein the storing unit is arranged to access the entries of the group in the order of the sequence of the code word components constituting the code word and wherein the storing unit is arranged to store a reference to the entry containing the code word component of the previously stored code word component in the sequence, if present.

9. A data structure (102) for storing code words identifying respective data items, each code word comprising a sequence of code word components, in which data structure a particular code word identifying a particular data item is stored in a group of entries with the following organization:
1) each entry (110, 112) of the group contains a particular one of the code word components of the particular code word,
2) each entry (110, 112) of the group contains a reference to an entry containing the code word component of a neighboring code word component of the particular code word, if present, to allow reconstruction of the particular code word from the entries of the group,
3) at least one entry (110) of the group contains a reference to the particular data item.
